(19) United States
(12) Patent Application Publication
(10) Pub. No.: US 2003/0179183 A1
(43) Pub. Date: Sep. 25, 2003

(54) Wireless mouse having a micro movement sensor for sensing a movement thereof

(76) Inventor: Yuan-Chen Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/101,417

(22) Filed: Mar. 20, 2002

(51) Int. Cl. G09G 5/08

(52) U.S. Cl. 345/163

(57) ABSTRACT

A wireless mouse comprises a micro movement sensor, a CPU a high-frequency transmission module, a coordinate input module, an electronic switch, and a battery wherein coordinate input module is coupled to CPU, and electronic switch is coupled to CPU, high-frequency transmission module, and micro movement sensor, and battery respectively. Electronic switch is deactivated when mouse is not moved. When mouse is moved, micro movement sensor is activated to generate a signal which is in turn sent to the switch for activation, thereby enabling CPU and high-frequency transmission module. By sensing a movement of the mouse, a power saving of all components thereof is achieved.

### FIELD OF THE INVENTION

The present invention relates to movement sensing device of mouse and more particularly to a wireless mouse having an improved micro movement sensor for sensing a movement thereof so as to effectively save electrical energy thus consumed.

### BACKGROUND OF THE INVENTION

Pointing devices such as mice are well known peripherals for personal computers and workstations. Such pointing devices allow rapid relocation of the cursor on a display screen, and useful in many text, database, and graphical programs. Perhaps the most common form of pointing device is electronic mouse.

Wired mice have been developed for more than two decades. Such conventional mouse typically has a cord electrically coupled to computer for sending instructions of user thereto. In use, however, such wired mouse is not convenient because the relatively long cord may interfere the movement of mouse. Further, user may be annoyed in storing the cord. Furthermore, the mouse typically incorporates a ball having internal shaft encoders and photosensor on an underside thereof. Ball moves over a reference table (such as a desktop) when the mouse is moved. As a result, a series of light pulses are received by the photosensor. Hence, the rotational movement of the ball can be converted to a digital representation useable to move the cursor. However, dust and the like may accumulate within the mouse by passing through a gap between the ball and the underside of mouse. This can adversely affect a sensitivity when moving the mouse. For overcoming above problem, wireless mice are developed recently. Another concern of saving electrical energy of mouse is also very important.

A power saving device of a conventional wireless mouse is shown in FIG. 1. The device comprises a sensing and count signals control circuit 50′ responsible for generating sensing and count signals, a sleep mode control circuit 71′ coupled to the sensing and count signals control circuit 50′ for receiving the sensing and count signals therefrom, an intermittent wakeup and timer control circuit 72′ coupled to the sleep mode control circuit 71′ responsible for receiving output signals therefrom and outputting sensing signals to the sensing and count signals control circuit 50′ for sensing whether mouse is moving or not, a light emitting diode (LED) driver 73′ coupled to the intermittent wakeup and timer control circuit 72′ so that a signal is outputted from a mouse being operating to the LED driver 73′ for causing the LED driver 73′ to emit light, and an oscillator circuit 60′ having an output terminal (e.g., OSC.DR) for outputting an oscillation signal, serving as a drive of other oscillator circuits, or serving as a power source, and another output terminal for sending signals to the intermittent wakeup and timer control circuit 72′ for effecting an accurate timer count. As to sleep signals, they are responsible for cutting off power of the LED driver 73′. However, there is no provision of cutting off power of the other remaining components of the device after a period of inactivity has been lapsed. Thus, a complete power saving is not possible. Thus improvement exists in order to overcome the above drawbacks of prior art.

### SUMMARY OF THE INVENTION

It is therefore an object of the present invention to provide a wireless mouse having a micro movement sensor wherein all of components of the wireless mouse are enabled only when a movement of the wireless mouse is sensed by the micro movement sensor so as to effectively save electrical energy thus consumed.

It is another object of the present invention to provide a wireless mouse having a micro movement sensor wherein a light emitter is enabled only when a movement of the wireless mouse is sensed by the micro movement sensor so as to effectively save electrical energy thus consumed.

To achieve the above and other objects, the present invention provides a wireless mouse comprising a micro movement sensor, a CPU (central processing unit), a high-frequency transmission module, a coordinate input module, an electronic switch, and a battery wherein the coordinate input module is coupled to the CPU, and the electronic switch is coupled to the CPU, the high-frequency transmission module, and the micro movement sensor, and the battery respectively so that the electronic switch is deactivated when the mouse is not moved, and when the mouse is moved, the micro movement sensor is activated to generate a signal which is in turn sent to the electronic switch for activation, thereby enabling the CPU and the high-frequency transmission module. By utilizing this, a power saving of all components of the wireless mouse is achieved.

The above and other objects, features and advantages of the present invention will become apparent from the following detailed description taken with the accompanying drawings.

### BRIEF DESCRIPTION OF THE DRAWINGS

FIG. 1 is a block diagram of a power saving device of a conventional wireless mouse;

FIG. 2 is a block diagram of a first preferred embodiment of power saving device of a wireless mouse according to the invention;

FIG. 3 is a block diagram of a second preferred embodiment of power saving device of a wireless mouse according to the invention;

FIG. 4 is a circuit diagram of micro movement sensor shown in FIG. 2 or 3;

FIG. 5 is a perspective view of piezoelectric element shown in FIG. 4; and

FIG. 6 is a block diagram of a third preferred embodiment of power saving device of a wireless mouse according to the invention.

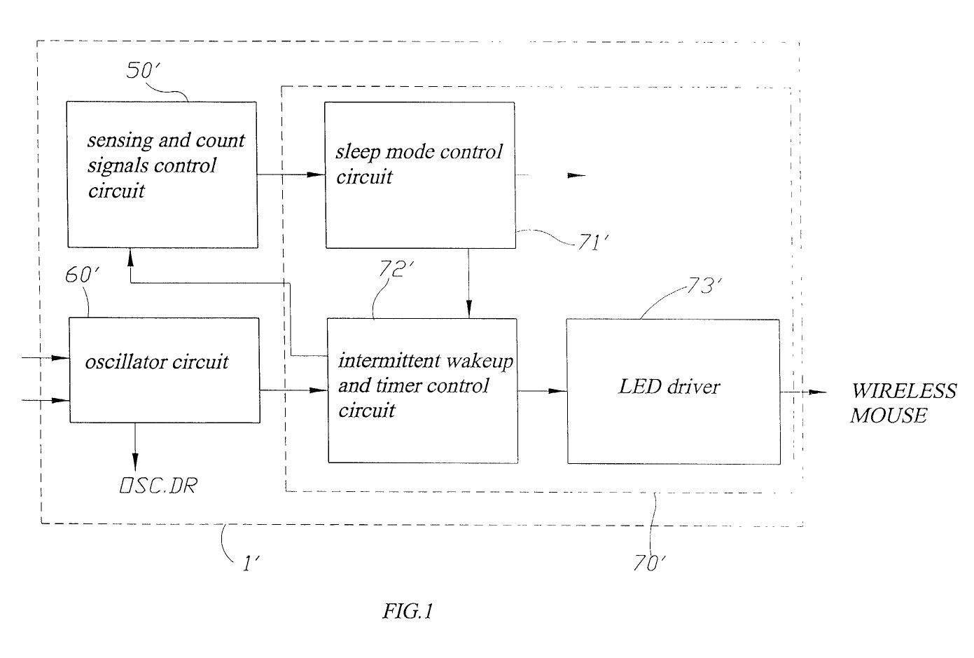

### DETAILED DESCRIPTION OF THE PREFERRED EMBODIMENTS

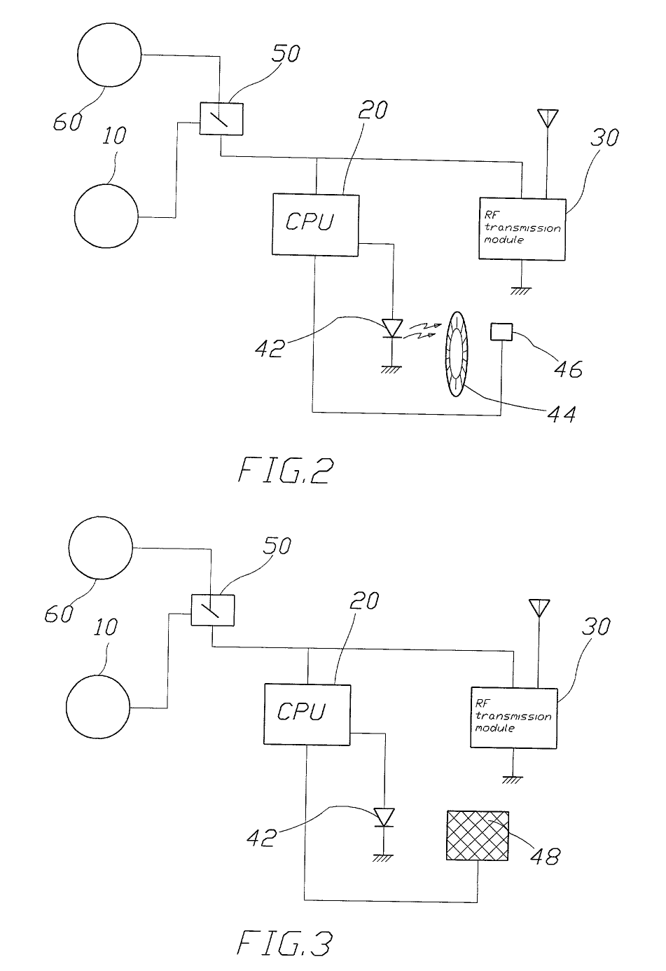

Referring to FIG. 2, there is shown a first preferred embodiment of power saving device of a wireless mouse constructed in accordance with the invention. The device comprises a micro movement sensor 10, a CPU (central processing unit) 20, a high-frequency transmission module (e.g., RF transmission module) 30, at least one coordinate input module 40, an electronic switch 50, and a battery 60. Coordinate input module 40 is coupled to CPU 20. Electronic switch 50 is coupled to CPU 20, high-frequency transmission module 30, micro movement sensor 10, and battery 60 respectively. In the embodiment coordinate input module 40 consists of a light emitter 42, a grid wheel 44, and a photosensor 46 coupled to CPU 20. When mouse is moved, light emitter 42 emits light and grid wheel 44 rotates simultaneously. Then, a series of light pulses, generated as light impinged on grid wheel 44, are received by photosensor 46. Next, a signal is generated in photosensor 46. Such signal is in turn sent to CPU 20 for processing. Then CPU 20 determines a direction and a speed of the moving mouse. Such direction and speed data is converted into a digital representation which is further transmitted from high-frequency transmission module 30 to computer in a wireless manner.

Referring to FIG. 3, there is shown a second preferred embodiment of power saving device of a wireless mouse constructed in accordance with the invention. The difference between first and second preferred embodiments is that grid wheel 44 and photosensor 46 are replaced by an image sensor 48. Similar to the first embodiment, when mouse is moved, light emitter 42 emits light. A reflectance of light over a reference surface (e.g., desktop) is received by image sensor 48. Next, a signal is generated in image sensor 48. Such signal is in turn sent to CPU 20 for processing. Then CPU 20 determines a direction and a speed of the moving mouse. Such direction and speed data is converted into a digital representation which is further transmitted from high-frequency transmission module 30 to computer in a wireless manner.

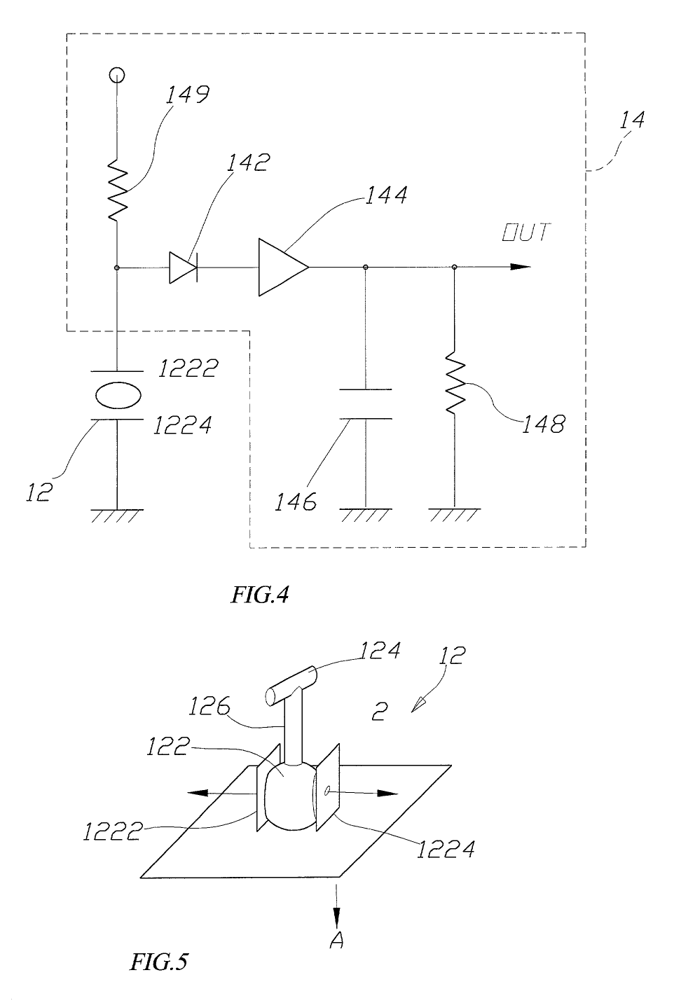

Referring to FIGS. 4 and 5, there is shown the micro movement sensor 10 of wireless mouse of the invention. The micro movement sensor 10 comprises a piezoelectric element 12 including a piezoelectric transistor (e.g., piezoelectric ceramic transistor) 122, a horizontal bar 124, and a post 126 having an upper end coupled to the horizontal bar 124 and a lower end pivotably coupled to the piezoelectric transistor 122; and a micro movement sensing circuit 14 including a rectifier module 142, an amplifier module 144, a charger module 146, a discharger module 148, and a bias module 149. Piezoelectric element 12 is mounted on a circuit board A. Piezoelectric transistor 122 is fixed onto circuit board A. When the mouse is moved, the horizontal bar 124 is pivoted to generate a torque. The piezoelectric transistor 122 is deformed because a force resulting from the torque is exerted thereon. As a result, a small number of charges are generated. The charges are then outputted in a form of current from a positive terminal 1222 to a negative terminal 1224. The rectifier module 142 coupled to piezoelectric element 12 is responsible for converting the current into a direct current. Amplifier module 144 coupled to the rectifier module 142 is responsible for amplifying the current. Both charger module 146 and discharger module 148 are coupled to the amplifier module 144, i.e., charger module 146 and discharger module 148 are parallel connected. The bias module 149 is coupled to piezoelectric element 12. In the embodiment, charger module 146 is implemented as a capacitor and discharger module 148 is implemented as a resistor. Micro movement sensing circuit 14 has an output terminal. Electronic switch 50 is off when the mouse is not moved. When the mouse is moved, micro movement sensor 10 is also slightly moved or vibrated. As a result, the output terminal of micro movement sensing circuit is at a high voltage level. Electronic switch 50 is on because the output terminal of micro movement sensing circuit is at a high voltage level. As an end, both CPU 20 and high-frequency transmission module 30 are enabled to activate the whole circiutry of mouse.

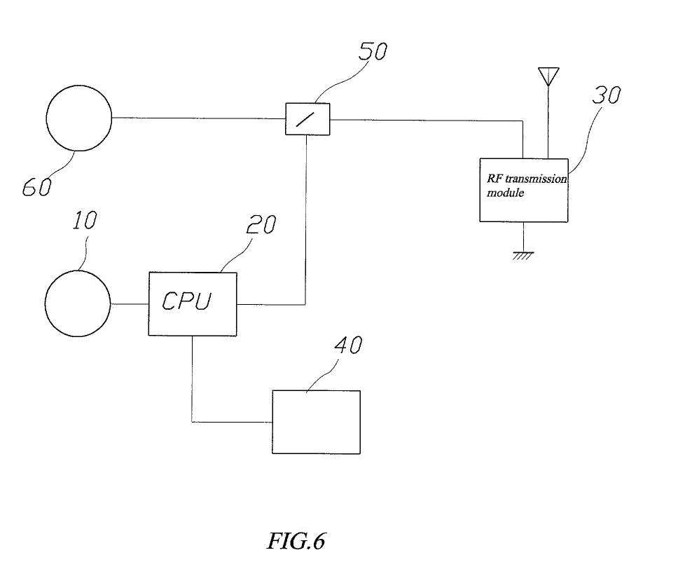

Referring to FIG. 6, there is shown a third preferred embodiment of power saving device of a wireless mouse constructed in accordance with the invention. The differences between first and third preferred embodiments are that coordinate input module 40 is coupled to CPU 20, one terminal of CPU is coupled to micro movement sensor 10, the other terminal of CPU is coupled to electronic switch 50, and electronic switch 50 has one terminal coupled to high-frequency transmission module 30 and the other terminal coupled to battery 60. In an unused state, CPU 20 is at a low voltage level. When the mouse is moved, a signal is generated from micro movement sensor 10. Next, the output terminal of micro movement sensing circuit is at a high voltage level. Then light emitter 42 is enabled by CPU 20 to emit light. Next, coordinate input module 40 is enabled to generate a signal. Such signal is sent to CPU 20 to turn on electronic switch 50. A digital representation of direction and speed of the moving mouse is sent to high-frequency transmission module 30 and further transmitted therefrom to computer in a wireless manner.

A conventional wireless mouse has to continuously or continually enable light emitter. Hence, power consumed is large. In a typical example, the consumed current is about 200 μA. In contrast, the wireless mouse of the invention incorporating micro movement sensor 10 for sensing a movement of the mouse only consumes about 20 μA prior to activating the whole system of wireless mouse. This is a great improvement.

While the invention has been described by means of specific embodiments, numerous modifications and variations could be made thereto by those skilled in the art without departing from the scope and spirit of the invention set forth in the claims.

What is claimed is:

1. A wireless mouse comprising a micro movement sensor, a CPU (central processing unit), a high-frequency transmission module, a coordinate input module, an electronic switch, and a battery wherein the coordinate input module is coupled to the CPU, and the electronic switch is coupled to the CPU, the high-frequency transmission module, and the micro movement sensor, and the battery respectively so that the electronic switch is deactivated when the mouse is not moved, and when the mouse is moved, the micro movement sensor is activated to generate a signal which is in turn sent to the electronic switch for activation, thereby enabling the CPU and the high-frequency transmission module.

2. The wireless mouse of claim 1, wherein the micro movement sensor comprises a piezoelectric element including a piezoelectric transistor, a horizontal bar, and a post having an upper end coupled to the horizontal bar and a lower end pivotably coupled to the piezoelectric transistor, and a micro movement sensing circuit.

3. The wireless mouse of claim 2, wherein the micro movement sensing circuit comprises a rectifier module, an amplifier module, a charger module, a discharger module, and a bias module wherein the rectifier module is coupled to the piezoelectric element for current conversion, the bias module is coupled to the piezoelectric element, the amplifier module is coupled to the rectifier module, and both the charger module and the discharger module are coupled to the amplifier module.

4. The wireless mouse of claim 1, wherein the coordinate input module consists of a light emitter, a grid wheel, and a photosensor.

5. The wireless mouse of claim 1, wherein the coordinate input module consists of a light emitter and an image sensor.

6. The wireless mouse of claim 3, wherein the piezoelectric transistor is a piezoelectric ceramic transistor.

7. The wireless mouse of claim 3, wherein in response to the movement of the mouse the piezoelectric transistor is capable of generating charges which are further outputted in a form of current from a positive terminal to a negative terminal thereof.

8. The wireless mouse of claim 2, wherein the micro movement sensing circuit has an output terminal which is at a high voltage level when the mouse is moved.

9. The wireless mouse of claim 8, wherein when the output terminal of the micro movement sensing circuit is at the high voltage level, the electronic switch is activated, thereby enabling the CPU and the high-frequency transmission module.

10. The wireless mouse of claim 2, wherein the micro movement sensing circuit is coupled to the CPU so that the CPU is in a low power consumption state when the mouse is not moved, and when the mouse is moved, the micro movement sensor is activated to generate a signal which is in turn sent to the CPU for activation, thereby enabling the coordinate input module to turn on the electronic switch.
